(19) United States
(12) Patent Application Publication
(10) Pub. No.: US 2026/0213689 A1
(43) Pub. Date: Jul. 23, 2026

(54) Vibration Device

(71) Applicant: FOSTER ELECTRIC COMPANY, LIMITED, Tokyo (JP)

(72) Inventors: Yasuo Kawana, Akishima-shi, Tokyo (JP); Hitoshi Sadahiro, Akishima-shi, Tokyo (JP)

(21) Appl. No.: 19/138,788

(22) PCT Filed: Dec. 18, 2023
(86) PCT No.: PCT/JP2023/045359

§ 371 Date: Jun. 13, 2025

(30) Foreign Application Priority Data
Dec. 19, 2022 (JP) 2022-202447

(51) Int. Cl. H02P 25/034; G01D 5/14; H02K 33/18

(52) U.S. Cl. CPC H02P 25/034; G01D 5/14; H02K 33/18

(57) ABSTRACT

A vibration device includes a vibrator that imparts vibration, a displacement detection section that detects displacement of the vibrator or a housing, and a controller that causes the vibrator to vibrate based on an input drive signal and detection information of the displacement detection section.

### TECHNICAL FIELD

The technology of the present disclosure relates to a vibration device.

### RELATED ART

Japanese Patent Application Laid-Open (JP-A) No. 2021-186710 discloses a technique in which vibration is mechanically suppressed so as to obtain a vibration suppression effect and durability by disposing plural coil springs at both sides of a movable element.

### SUMMARY OF THE INVENTION

### Problem to be Solved by the Invention

Note that it is preferable to suppress contact of a vibrator with a housing.

In consideration of the above-described circumstances, an object of the technology of the present disclosure is to provide a vibration device that is capable of suppressing contact of a vibrator with a housing.

### Means for Solving the Problem

An aspect of the present disclosure is a vibration device that includes: a vibrator that imparts vibration; a displacement detection section that detects displacement of the vibrator or a housing; and a controller that causes the vibrator to vibrate based on an input drive signal and detection information of the displacement detection section.

### Effect of the Invention

As explained above, the vibration device of the technology of the present disclosure enables a vibrator to be suppressed from contacting a housing.

### BRIEF DESCRIPTION OF THE DRAWINGS

FIG. 1 is a schematic diagram of a vibration device according to an exemplary embodiment of the technology of the present disclosure.

FIG. 2 is a block diagram illustrating a configuration of a controller of a vibration device according to a first exemplary embodiment of the technology of the present disclosure.

FIG. 3 is a diagram for explaining an adjustment method of a control signal.

FIG. 4 is a diagram for explaining a method of adjusting a level of a drive signal so as to be suppressed, in a case in which a compression ratio is “2:1” and a threshold value TH is “10”.

FIG. 5 is a diagram for explaining a method of adjusting a level of a drive signal so as to be suppressed, in a case in which a compression ratio is “3:1” and a threshold value TH is “15”.

FIG. 6 is a flowchart illustrating a vibration control processing routine by a controller of a vibration device according to a first exemplary embodiment of the technology of the present disclosure.

FIG. 7A is a diagram for explaining a method of adjusting a level of a drive signal so as to be suppressed, in accordance with a combination of a direction of movement and an acceleration of a vibrator.

FIG. 7B is a diagram for explaining a method of adjusting a level of a drive signal so as to be suppressed, in accordance with a combination of a direction of movement and an acceleration of a vibrator.

FIG. 7C is a diagram for explaining a method of adjusting a level of a drive signal so as to be suppressed, in accordance with a combination of a direction of movement and an acceleration of a vibrator.

FIG. 7D is a diagram for explaining a method of adjusting a level of a drive signal so as to be suppressed, in accordance with a combination of a direction of movement and an acceleration of a vibrator.

FIG. 8 is a block diagram illustrating a configuration of a controller of a vibration device according to a fourth exemplary embodiment of the technology of the present disclosure.

FIG. 9 is a flowchart illustrating a vibration control processing routine by a controller of a vibration device according to a fourth exemplary embodiment of the technology of the present disclosure.

FIG. 10 is a block diagram illustrating a configuration of a controller of a vibration device according to a fifth exemplary embodiment of the technology of the present disclosure.

FIG. 11 is a flowchart illustrating a vibration control processing routine by a controller of a vibration device according to a fifth exemplary embodiment of the technology of the present disclosure.

FIG. 12 is a block diagram illustrating a configuration of a controller of a vibration device according to a sixth exemplary embodiment of the technology of the present disclosure.

FIG. 13 is a block diagram illustrating a configuration of a controller of a vibration device according to a seventh exemplary embodiment of the technology of the present disclosure.

FIG. 14 is a graph illustrating changes in each of a control signal, a magnetic force, and a position of a vibrator.

FIG. 15A is a perspective view illustrating a configuration of a vibration device according to conventional technology.

FIG. 15B is a schematic diagram illustrating a stationary state of a vibration device according to conventional technology.

FIG. 16A is a schematic diagram illustrating a drive state of a vibration device according to conventional technology.

FIG. 16B is a schematic diagram illustrating a drive state of a vibration device according to conventional technology.

FIG. 16C is a schematic diagram illustrating a drive state of a vibration device according to conventional technology.

FIG. 17 is a schematic diagram of a vibration device according to an eighth exemplary embodiment of the technology of the present disclosure.

FIG. 18A is a cross-sectional view illustrating a configuration of an actuator of a vibration device according to an eighth exemplary embodiment of the technology of the present disclosure.

FIG. 18B is a schematic diagram illustrating a configuration of an actuator of a vibration device according to an eighth exemplary embodiment of the technology of the present disclosure.

FIG. 19A is a schematic diagram illustrating a connection relationship between an actuator and a controller of a vibration device according to an eighth exemplary embodiment of the technology of the present disclosure.

FIG. 19B is a diagram illustrating a configuration of a magnetic circuit that includes a single coil.

FIG. 20A are graphs illustrating a magnitude, an x component, and a z component of magnetic flux with respect to displacement at the center of a side face of a housing of a magnetic circuit that includes a pair of coils.

FIG. 20B are graphs illustrating a magnitude, an x component, and a z component of magnetic flux with respect to displacement at the center of a top face of a housing of a magnetic circuit that includes a pair of coils.

FIG. 21A are graphs illustrating a magnitude, an x component, and a z component of magnetic flux with respect to displacement at the center of a side face of a housing of a magnetic circuit that includes a single coil.

FIG. 21B are graphs illustrating a magnitude, an x component, and a z component of magnetic flux with respect to displacement at the center of a top face of a housing of a magnetic circuit that includes a single coil.

FIG. 21C are graphs illustrating a magnitude, an x component, and a z component of magnetic flux with respect to displacement at the center of a bottom face of a housing of a magnetic circuit that includes a single coil.

FIG. 21D are graphs illustrating a magnitude, an x component, and a z component of magnetic flux with respect to displacement, at a position of 4 mm from the center of a side face of a housing to a coil side of a magnetic circuit that includes a single coil.

### MODE FOR IMPLEMENTING THE INVENTION

Detailed explanation follows regarding exemplary embodiments of the technology of the present disclosure, with reference to the drawings.

### Summary of Exemplary Embodiments of the Technology of the Present Disclosure

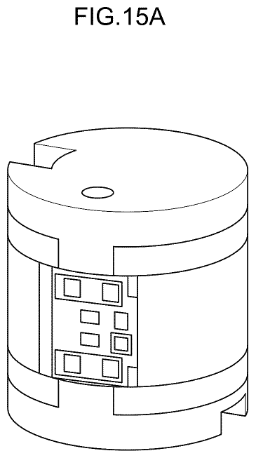

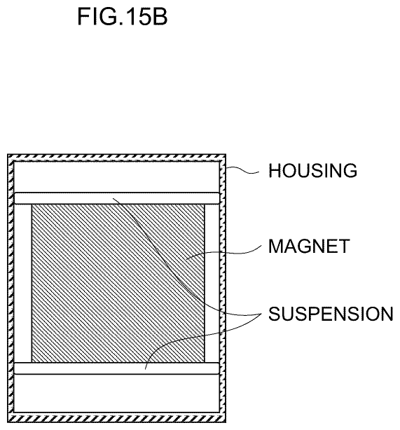

A voice coil type actuator, such as that illustrated in FIG. 15A, is used in order to transmit vibration to a hand, a body, or the like, and to reproduce feeling, touch, and the like in a pseudo manner. Voice coil type actuators are built into game controllers, massage devices, or the like, and environments in which voice coil type actuators are used, such as being held in the hand or in contact with the body, are not constant in many cases.

As illustrated in FIG. 15B, a voice coil type actuator includes a magnet that is supported by a suspension inside a housing. FIG. 15B is a cross-sectional view illustrating an example of an internal structure of a voice coil type actuator in a stationary state. During driving of a voice coil type actuator, there are sometimes cases in which an internal magnet physically contacts an inner wall of the housing, depending on the usage state, and an abnormal sound is generated. In particular, this occurs notably in devices (for example, game controllers, massage devices, and the like) that are used while held in the hand, in which the usage state is not constant. Further, this easily occurs particularly when driving is performed using a drive signal close to the resonance frequency of the voice coil type actuator or a maximum allowable drive signal, which are used in cases in which large vibration is desired to be transmitted.

Specific explanation follows regarding a usage state in which an abnormal sound is generated.

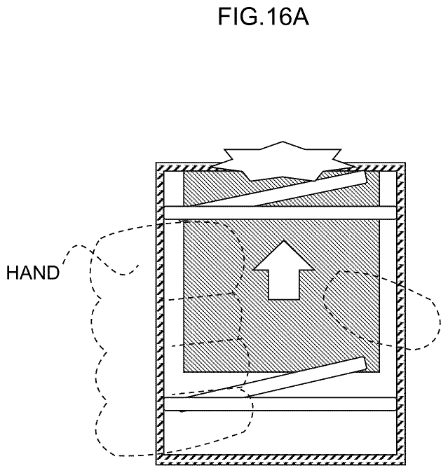

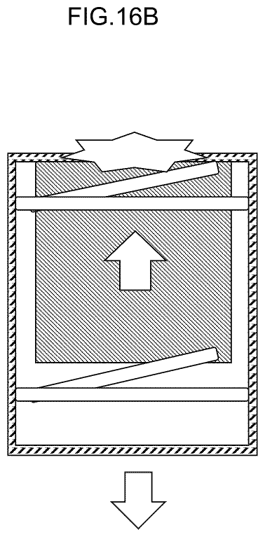

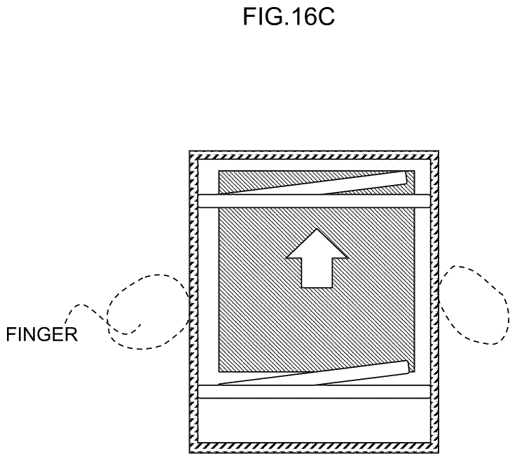

First, as illustrated in FIG. 16A, there are sometimes cases of a large load on a voice coil type actuator, such as by strongly gripping or pressing a device that is installed with the voice coil type actuator. In such cases, a device main body and the housing itself of the voice coil type actuator are physically fixed, a relative amount of movement of a magnet with respect to the housing of the voice coil type actuator becomes the maximum, and the magnet easily contacts the inner wall of the housing.

Further, as illustrated in FIG. 16B, in a case in which a load on a voice coil type actuator is extremely light (the voice coil type actuator is free), the housing is excessively shaken, a relative amount of movement of the magnet with respect to the housing becomes large, the magnet and the housing contact each other, and an abnormal sound is generated.

On the other hand, as illustrated in FIG. 16C, in a case in which there is an appropriate load on a voice coil type actuator, the device main body shakes and is offset by vibration of the magnet of the voice coil type actuator, a relative amount of movement of the magnet with respect to the housing becomes small, and contact with the housing becomes unlikely to occur.

It would be conceivable to prevent contact of the magnet with the housing by making the drive signal, which is to be input in accordance with the usage state in which the abnormal sound is generated, uniformly smaller, namely, by narrowing the dynamic range; however, vibration becomes small overall, and the feeling that is transmitted also becomes weak.

Therefore, in an exemplary embodiment of the technology of the present disclosure, a magnetic detection sensor is provided at an outer side of a housing of an actuator, a direction of movement and an acceleration of a vibrator are specified based on a change in the position of an internal vibrator (magnet) that changes on input, and the level of a control signal is controlled based on the direction of movement and the acceleration, such that movement of the vibrator is suppressed just before the vibrator physically collides with the housing, or a control signal corresponding to a difference compared to the input drive signal is output to an actuator 10, thereby controlling vibration of a vibrator 12. Directly capturing the movement of the vibrator and using it in drive control of the vibrator enables various physical load variations to be accommodated. Further, control is also possible with respect to input of an excessive drive signal, in order to capture movement of the vibrator.

The direction of movement can be specified based on the input drive signal and a sensor signal input from the magnetic detection sensor, such that the magnetic detection sensor can be provided at any position at an outer side of the housing. This enables application to actuators of various existing shapes. Namely, it is not necessary to change existing actuators.

### First Exemplary Embodiment

### Configuration of the Vibration Device of the First Exemplary Embodiment of the Technology of the Present Disclosure

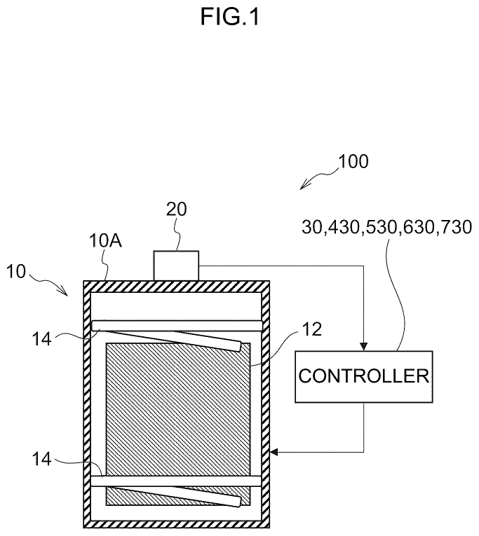

FIG. 1 is a schematic diagram of a vibration device 100 according to an exemplary embodiment of the technology of the present disclosure.

As illustrated in FIG. 1, the vibration device 100 includes the actuator 10, a magnetic detection sensor 20 that is provided at a surface of a housing 10A, and a controller 30. The actuator 10 includes the housing 10A, the vibrator 12 that is provided inside the housing 10A, and a suspension 14 that supports the vibrator 12. The actuator 10 is configured, for example, by a voice coil type actuator.

The magnetic detection sensor 20 detects a magnetic force, which is a magnitude of magnetism from the vibrator 12 and which changes due to input of a drive signal. Since the vibrator 12 moves inside the housing 10A due to input of a drive signal, a difference in magnetic force is detected based on a positional relationship between the vibrator 12 and the magnetic detection sensor 20. A linear type Hall element, for example, can be used as the magnetic detection sensor 20.

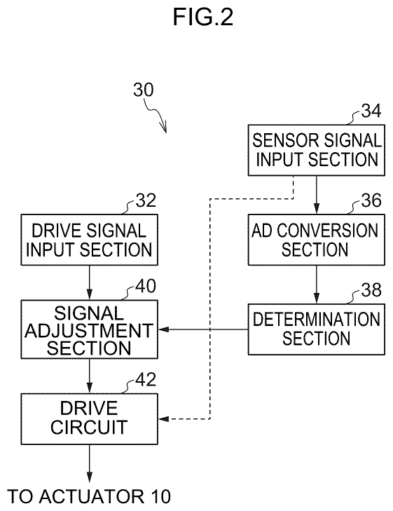

As illustrated in FIG. 2, the controller 30 includes a drive signal input section 32, a sensor signal input section 34, an AD conversion section 36, a determination section 38, a signal adjustment section 40, and a drive circuit 42.

The drive signal input section 32 receives input of a drive signal from the outside (for example, from an audio player, a game controller, a massage device, or the like). Note that although, as an example, description has been made taking a case in which an input of a drive signal is received from the outside, the present disclosure is not limited thereto. For example, a signal pattern or a sound source signal stored in advance, or a signal pattern or a sound source signal generated by a program may be received as a drive signal.

The sensor signal input section 34 receives input of a sensor signal in accordance with a magnetic force detected from the magnetic detection sensor 20.

The AD conversion section 36 performs AD conversion of the sensor signal received by the sensor signal input section 34, and outputs a digital signal.

The determination section 38 determines whether or not the magnetic force detected by the magnetic detection sensor 20 is greater than or equal to a threshold value based on the output of the AD conversion section 36.

In a case in which it is determined that the magnetic force detected by the magnetic detection sensor 20 is greater than or equal to the threshold value, the signal adjustment section 40 adjusts the level of the drive signal, based on the magnetic force detected by the magnetic detection sensor 20, so as to be suppressed.

The drive circuit 42 outputs a control signal to the actuator 10 so as to cause the vibrator 12 to vibrate in accordance with the drive signal.

Next, explanation follows regarding an adjustment method by the signal adjustment section 40.

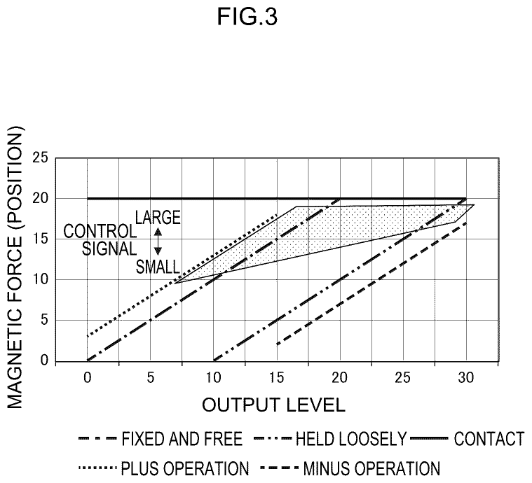

Various usage methods and fixing methods are conceivable for the vibration device 100. FIG. 3 illustrates the correspondence relationship between the level of the drive signal and the detected magnetic force in various usage methods and fixing methods.

As illustrated in FIG. 3, in a case in which the main body is firmly fixed, or in a case of a floating state with the main body being completely free (see the dash-dot line in FIG. 3), magnetic force is detected along a line starting from the drive signal level “0”.

Further, in a case in which the vibrator is held loosely to some extent and the swing width of the vibrator is relatively minimum (see the dash-double-dot line in FIG. 3), magnetic force is detected along a line starting from the drive signal level “10”.

In a case in which it is assumed that the main body, such as a game controller, is moved (see the dotted line and the dashed line in FIG. 3), it is also conceivable that the main body is moved in a direction that is larger than in cases in which the main body is firmly fixed or that is smaller than in cases in which the main body is held loosely to some extent, and effective control is required in cases such as these as well.

Therefore, the drive signal level is adjusted in the dot region illustrated in FIG. 3. In the dot region, the higher in the dot region, the larger the adjustment that is made.

Explanation follows regarding an example in the present exemplary embodiment in which a compression method is used as a method of adjusting the drive signal. In the compression method, the magnetic force detected by the magnetic detection sensor 20 is used as a position of the vibrator 12 (a permanent magnet), and in a case in which the value exceeds a set threshold value TH, the output level of the drive signal is adjusted using a set compression ratio.

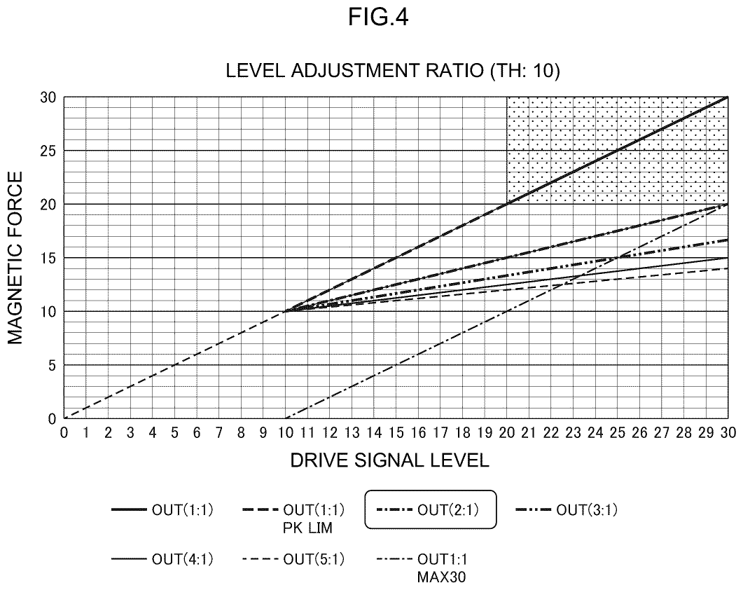

As illustrated in FIG. 4, for example, in a case in which the threshold value TH is “10”, adjustment is performed such that the output level of the drive signal is suppressed at or above the magnetic force “10” at a predetermined compression ratio. Note that when the magnetic force becomes greater than or equal to “20”, a peak is reached (in contact with the housing 10A) (see the dot region in FIG. 4). Further, the output level is permitted up to “30”.

Assuming that the compression ratio is “2:1”, it is possible to output and handle “30”, which is the upper limit of the output level of the drive signal, even with a maximum value “20” of the magnetic force. Note that a triangular region (the gray region in FIG. 4) connecting the threshold value TH “10”, the magnetic force “20”, and the output level “30” of the drive signal cannot be used. Further, when attempting to adjust the output level of the drive signal to the magnetic force “20” at the output level “30” without suppressing the output level of the drive signal, it is necessary to suppress the output level of the drive signal entirely so that the maximum value of the magnetic force becomes “20” (see the thin dash-dot line (OUT 1:1 MAX 30) in FIG. 4). In such cases, the transmitted vibration becomes small overall.

In a case of exceeding the threshold value TH, the compression ratio is used as a ratio that compresses an amount that exceeds the input level of the drive signal corresponding to the threshold value TH, and may be, for example, “2:1”, “3:1”, “4:1”, or the like.

For example, in a case in which an amount exceeding the input level “10” corresponding to the threshold value “10” of the magnetic force is set to “10”, the output level of each compression ratio is as follows.

| Compression Ratio | Output |
|---|---|
| 2:1 → | 15 (=10 + 5) |
| 3:1 → | 13.3 (=10 + 3.3) |
| 4:1 → | 12.5 (=10 + 2.5) |
| 5:1 → | 12 (=10 + 2) |

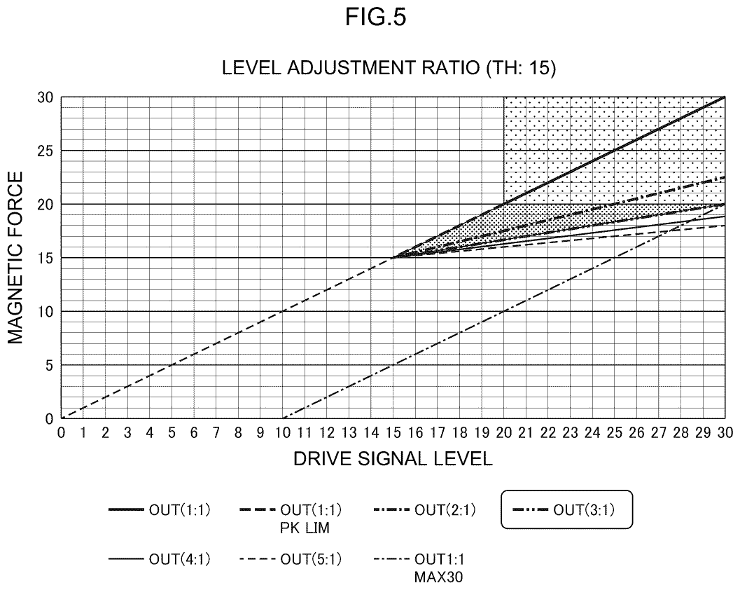

As illustrated in FIG. 5, in a case in which the threshold value TH is “15”, adjustment is performed such that the output level of the drive signal is suppressed at or above the magnetic force “15” at a predetermined compression ratio. Assuming that the compression ratio is “3:1”, it is possible to output and handle “30”, which is the upper limit of the output level of the drive signal, even with a maximum value “20” of the magnetic force. Note that a triangular region (the gray region in FIG. 5) connecting the threshold value TH “15”, the magnetic force “20”, and the output level “30” cannot be used. However, this is smaller than the triangular region in the case of the threshold value TH “10” in above-described FIG. 4. Further, when attempting to adjust the output level of the drive signal to the magnetic force “20” at the output level “30” without suppressing the output level of the drive signal, it is necessary to suppress the output level of the drive signal entirely so that the maximum value of the magnetic force becomes “20” (see the thin dash-dot line (OUT 1:1 MAX 30) in FIG. 5). In such cases, the transmitted vibration becomes small overall.

From above-described FIG. 4 and FIG. 5, setting the threshold value TH as high as possible, and decreasing the compression ratio enables a large output level to be efficiently obtained until just before a peak is reached.

Ideally, suppression should be carried out immediately before reaching a peak, such as a peak limiter (see the bold dashed line (OUT (1:1) PK LIM)) in above-described FIG. 4 and FIG. 5; however, it is difficult to abruptly stop mechanically. Similarly, in a case in which the threshold value TH is excessively raised, there is less room to reach a peak (headroom), and therefore, it is necessary to determine a balance with physical vibration characteristics of the vibrator 12.

In this manner, the signal adjustment section 40 uses the magnetic force detected by the magnetic detection sensor 20 as the position of the vibrator 12, which is a permanent magnet, controls the output level of the drive signal based on the value, and performs position control of the vibrator 12. Namely, as a result of movement inside the housing 10A due to input of the drive signal, a difference in magnetic force is detected based on the positional relationship between the vibrator 12 and the magnetic detection sensor 20, and the output level of the drive signal is adjusted.

### Operation of the Vibration Device of the First Exemplary Embodiment of the Technology of the Present Disclosure

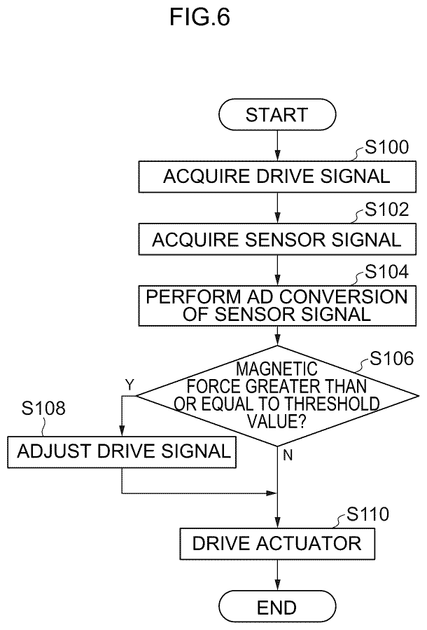

The controller 30 receives input of a drive signal from the outside. Further, the controller 30 receives input of a sensor signal from the magnetic detection sensor 20. When this occurs, the controller 30 repeatedly executes a vibration control processing routine illustrated in FIG. 6.

At step S100, the drive signal input section 32 acquires the input drive signal.

At step S102, the sensor signal input section 34 acquires the input sensor signal.

At step S104, the AD conversion section 36 performs AD conversion of the sensor signal received by the sensor signal input section 34, and outputs a digital signal.

At step S106, the determination section 38 determines whether or not the magnetic force detected by the magnetic detection sensor 20 is greater than or equal to a threshold value, based on the output of the AD conversion section 36. In a case in which the magnetic force detected by the magnetic detection sensor 20 is less than the threshold value, the processing transitions to step S110 without adjusting the drive signal. On the other hand, in a case in which the magnetic force detected by the magnetic detection sensor 20 is greater than or equal to the threshold value, the processing transitions to step S108.

At step S108, in a case in which it is determined that the magnetic force detected by the magnetic detection sensor 20 is greater than or equal to the threshold value, the signal adjustment section 40 adjusts the level of the drive signal so as to suppressed.

At step S110, the drive circuit 42 outputs a control signal, to the actuator 10, for driving the vibrator 12 in accordance with the drive signal acquired at above-described step S100 or the drive signal adjusted at above-described step S108.

As explained above, in the vibration device according to the first exemplary embodiment of the technology of the present disclosure, magnetic force according to displacement of the vibrator is detected by the magnetic detection sensor. The controller adjusts the input drive signal in accordance with the magnetic force, and causes the vibrator of the actuator to vibrate based on the adjusted drive signal. This enables the vibrator to be suppressed from contacting the housing.

### Second Exemplary Embodiment

Next, explanation follows regarding a vibration device according to a second exemplary embodiment. Portions having the same configuration as those in the first exemplary embodiment are appended with the same reference numerals, and explanation thereof is omitted.

In the second exemplary embodiment a method of adjusting a drive signal is different from that in the first exemplary embodiment.

In a case in which it is determined that the magnetic force detected by the magnetic detection sensor 20 is greater than or equal to a threshold value, the signal adjustment section 40 of the controller 30 of the vibration device 100 according to the second exemplary embodiment adjusts the level of the drive signal based on the magnetic force detected by the magnetic detection sensor 20 and the level of the drive signal.

Specifically, the level of the drive signal is adjusted in accordance with a combination of the magnetic force detected by the magnetic detection sensor 20 and the level of the current drive signal.

More specifically, as illustrated in Table 1, in a case in which the magnetic force is greater than or equal to “18”, adjustment is performed so as to strongly suppress the level of the drive signal. When this occurs, adjustment is performed so as to strongly suppress the level of the drive signal, regardless of the current level of the drive signal.

In a case in which the magnetic force is less than “18” and is greater than or equal to 10″, adjustment is performed so as to suppress the level of the drive signal in accordance with the current level of the drive signal. When this occurs, in a case in which the level of the drive signal is high, adjustment is performed so as to weakly suppress the level of the drive signal. On the other hand, in a case in which the level of the drive signal is low, adjustment is performed so as to strongly suppress the level of the drive signal.

Further, in a case in which the magnetic force is less than “10”, the level of the drive signal is not adjusted, regardless of the current level of the drive signal. Alternatively, adjustment is so as to raise the level of the drive signal, conversely, in accordance with the level of the current drive signal.

TABLE 1

| No | Magnetic Force | Signal Level | Adjustment |
|---|---|---|---|
| 1 | H ≥ 18 | — | MAX |
| 2 | 18 > H ≥ 10 | Low | Strong |
| 3 | | High | Weak |
| 4 | 10 > H | Low to High | None to Inverse Adjustment |

Note that the other configurations and operations of the vibration device 100 according to the second exemplary embodiment are the same as those in the first exemplary embodiment, and explanation thereof is omitted.

As explained above, in the vibration device according to the second exemplary embodiment, magnetic force according to displacement of the vibrator is detected by the magnetic detection sensor. The controller adjusts the input drive signal in accordance with a combination of the magnetic force and the level of the drive signal, and causes the vibrator of the actuator to vibrate based on the adjusted drive signal. This enables the vibrator to be suppressed from contacting the housing, and to transmit vibration appropriately.

### Third Exemplary Embodiment

Next, explanation follows regarding a vibration device according to a third exemplary embodiment. Portions having the same configuration as those in the first exemplary embodiment are appended with the same reference numerals, and explanation thereof is omitted.

In the third exemplary embodiment, a method of adjusting a drive signal is different from those in the first exemplary embodiment and the second exemplary embodiment.

In a case in which it is determined that the magnetic force detected by the magnetic detection sensor 20 is greater than or equal to a threshold value, the signal adjustment section 40 of the controller 30 of the vibration device 100 according to the third exemplary embodiment specifies the direction of movement and the acceleration of the vibrator 12 based on the change in magnetic force per unit time detected by the magnetic detection sensor 20. The signal adjustment section 40 adjusts the level of the drive signal, based on the direction of movement and the acceleration of the vibrator 12, so as to be suppressed.

Specifically, adjustment is performed so as to suppress the level of the drive signal in accordance with a combination of the direction of movement, the magnetic force, the level of the drive signal, and the acceleration of the vibrator 12.

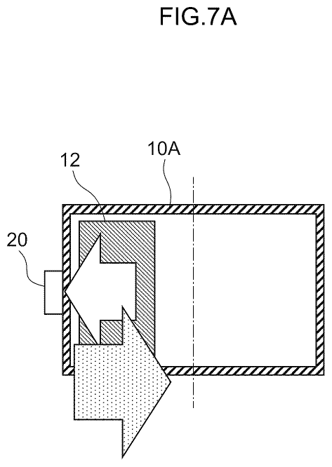

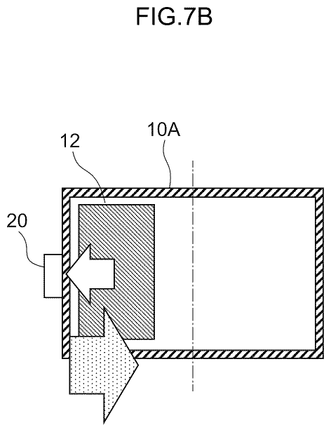

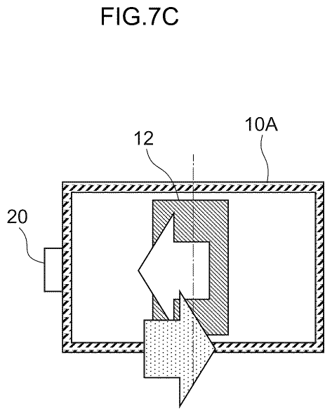

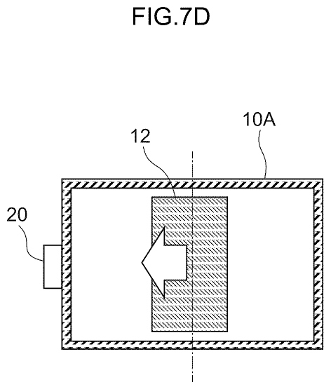

More specifically, as illustrated in Table 2, in a case in which the direction of movement of the vibrator 12 is in a direction approaching the magnetic detection sensor 20, and the acceleration is high, adjustment is performed so as to strongly suppress the level of the drive signal (see FIG. 7A). When this occurs, adjustment is performed so as to strongly suppress the level of the drive signal, regardless of the current level of the drive signal.

FIG. 7A illustrates an example of adjusting the level of the drive signal so as to be strongly suppressed (see the arrow mark filled with dots in FIG. 7A) in a case in which the vibrator 12 is closer to the magnetic detection sensor 20 than a reference position (see the dash-dot line in FIG. 7A) and the acceleration of the vibrator 12 is high (see the unfilled arrow mark in FIG. 7A).

In a case in which the direction of movement of the vibrator 12 is in a direction approaching the magnetic detection sensor 20 and the acceleration is low, adjustment is performed so as to weakly suppress the level of the drive signal (see FIG. 7B). FIG. 7B illustrates an example of adjusting the level of the drive signal so as to be suppressed in accordance with the current drive signal level (see the arrow mark filled with dots in FIG. 7B) in a case in which the vibrator 12 is closer to the magnetic detection sensor 20 than the reference position (see the dot-dash line in FIG. 7B) and the acceleration of the vibrator 12 is low (see the unfilled arrow mark in FIG. 7B).

Further, in a case in which the direction of movement of the vibrator 12 is in a direction approaching the magnetic detection sensor 20 and the acceleration is high, adjustment is performed so as to weakly suppress the level of the drive signal (see FIG. 7C). FIG. 7C illustrates an example of adjusting the level of the drive signal so as to be suppressed in accordance with the drive signal level (see the arrow mark filled with dots in FIG. 7C) in a case in which the vibrator 12 is moving away from the magnetic detection sensor 20 to the vicinity of the reference position (see the dot-dash line in FIG. 7C) and the acceleration of the vibrator 12 is high (see the unfilled arrow mark in FIG. 7C).

Further, in a case in which the direction of movement of the vibrator 12 is in a direction approaching the magnetic detection sensor 20 and the acceleration is low, the level of the drive signal is not adjusted (see FIG. 7D). Alternatively, adjustment is performed so as to raise the level of the drive signal, conversely, in accordance with the level of the current drive signal or application. FIG. 7D illustrates an example in which the level of the drive signal is not adjusted in a case in which the vibrator 12 is moving away from the magnetic detection sensor 20 to the vicinity of the reference position (see the dot-dash line in FIG. 7D) and the acceleration of the vibrator 12 is low (see the unfilled arrow mark in FIG. 7D).

TABLE 2

| | | Δt | | |
|---|---|---|---|---|
| Corre- | | Magnetic | | |
| sponding | | Force | | |
| Drawing | Magnetic Force | Change | Acceleration | Adjustment |
| FIG. 7A | Large | Large | High | MAX |
| | (Approaching) | | | |
| FIG. 7B | Large | Small | Low | Strong |
| | (Approaching) | | | to Weak |
| FIG. 7C | Small | Large | High | Strong |
| | (Moving Away) | | | to Weak |
| FIG. 7D | Small | Small | Low | None |
| | (Moving Away) | | | to Inverse |
| | | | | Adjustment |

In this manner, the acceleration and the direction of movement of the vibrator 12 are specified, and the level of the drive signal is adjusted such that the vibrator 12 does not collide with the housing 10A. In the case of the magnetic detection sensor 20, gradually increasing or decreasing magnetic force is detected, the position and the direction of movement of the vibrator 12 are specified, acceleration is calculated based on the change in magnetic force per unit time, and the level of the drive signal is adjusted. This is done intermittently. The higher the adjustment frequency, the more accurate the control becomes possible.

Note that the other configurations and operations of the vibration device 100 according to the third exemplary embodiment are the same as those in the first exemplary embodiment, and explanation thereof is omitted.

As explained above, in the vibration device according to the third exemplary embodiment, magnetic force according to displacement of the vibrator is detected by the magnetic detection sensor. The controller obtains the direction of movement and the acceleration of the vibrator based on change in magnetic force, adjusts the input drive signal in accordance with a combination of the direction of movement and the acceleration of the vibrator, and causes the vibrator of the actuator to vibrate based on the adjusted drive signal. This enables the vibrator to be suppressed from contacting the housing.

Further, vibration can be strongly felt by performing inverse adjustment, for example, in a case in which vibration is difficult to be transmitted despite a level of the drive signal being large. In particular, it is effective not only for game applications, but also for applications in which vibration must be reliably transmitted, such as a warning.

### Fourth Exemplary Embodiment

Next, explanation follows regarding a vibration device according to a fourth exemplary embodiment. Portions having the same configuration as those in the first exemplary embodiment are appended with the same reference numerals, and explanation thereof is omitted.

The fourth exemplary embodiment is different from the first exemplary embodiment to the third exemplary embodiment in that a brake signal for stopping vibration of the vibrator 12 is generated.

### Configuration of the Vibration Device of the Fourth Exemplary Embodiment of the Technology of the Present Disclosure

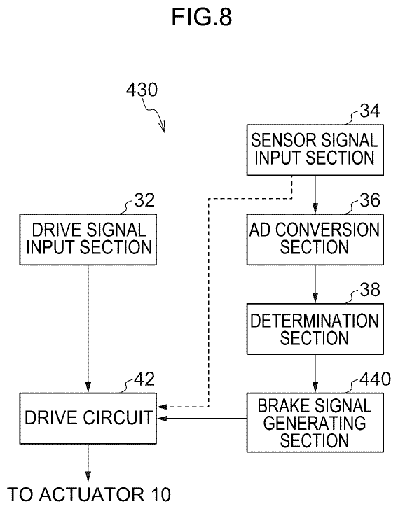

As illustrated in FIG. 8, a controller 430 includes the drive signal input section 32, the sensor signal input section 34, the AD conversion section 36, the determination section 38, a brake signal generating section 440, and the drive circuit 42.

In a case in which it is determined that the magnetic force detected by the magnetic detection sensor 20 is greater than or equal to a threshold value, the brake signal generating section 440 outputs a brake signal for stopping the driving of the vibrator 12.

Specifically, in order to forcibly stop vibration of the vibrator 12, the brake signal generating section 440 generates a signal that is opposite to the operation of the vibrator 12, or a signal with a DC component, and outputs the signal as a brake signal. Note that movement of the vibrator 12 is predicted from a change in the magnetic force detected by the magnetic detection sensor 20.

When this occurs, the brake signal generating section 440 uses the magnetic force detected by the magnetic detection sensor 20, generates a brake signal in accordance with the value, and performs position control of the vibrator 12. Namely, the greater the magnetic force, the more the brake signal is generated so as to forcibly stop the vibration of the vibrator 12.

The drive circuit 42 outputs, to the actuator 10, a control signal for causing the vibrator 12 to vibrate, in accordance with the drive signal and the brake signal. Specifically, the drive circuit 42 switches the drive signal to a brake signal, outputs a control signal to the actuator 10, and causes the vibrator 12 to vibrate.

### Operation of the Vibration Device of the Fourth Exemplary Embodiment of the Technology of the Present Disclosure

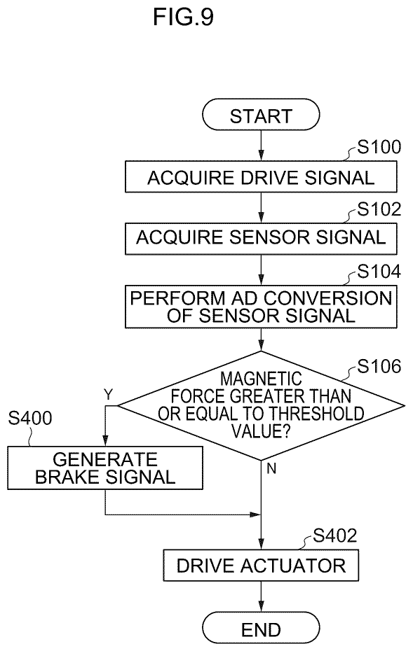

The controller 30 receives input of a drive signal from the outside. Further, the controller 30 receives input of a sensor signal from the magnetic detection sensor 20. When this occurs, the controller 30 repeatedly executes a vibration control processing routine illustrated in FIG. 9.

At step S100, the drive signal input section 32 acquires the input drive signal.

At step S102, the sensor signal input section 34 acquires the input sensor signal.

At step S104, the AD conversion section 36 performs AD conversion of the sensor signal received by the sensor signal input section 34, and outputs a digital signal.

At step S106, the determination section 38 determines whether or not the magnetic force detected by the magnetic detection sensor 20 is greater than or equal to a threshold value, based on the output of the AD conversion section 36. In a case in which the magnetic force detected by the magnetic detection sensor 20 is less than the threshold value, the processing transitions to step S402 without generating a brake signal. On the other hand, in a case in which the magnetic force detected by the magnetic detection sensor 20 is greater than or equal to the threshold value, the processing transitions to step S400.

At step S400, the brake signal generating section 440 outputs a brake signal for stopping the driving of the vibrator 12.

At step S402, the drive circuit 42 outputs, to the actuator 10, the drive signal acquired at above-described step S100 and a control signal corresponding to the brake signal generated at above-described step S400, and drives the actuator 10.

As explained above, in the vibration device according to the fourth exemplary embodiment, magnetic force according to displacement of the vibrator is detected by the magnetic detection sensor. A brake signal is generated by the controller in accordance with the magnetic force, and the vibrator of the actuator is caused to be vibrated based on the drive signal and the brake signal. This enables the vibrator to be suppressed from contacting the housing.

### Fifth Exemplary Embodiment

Next, explanation follows regarding a vibration device according to a fifth exemplary embodiment. Portions having the same configuration as those in the first exemplary embodiment are appended with the same reference numerals, and explanation thereof is omitted.

The fifth exemplary embodiment is different from the fourth exemplary embodiment in that a stop signal for stopping output of a control signal to the actuator 10 is generated.

### Configuration of the Vibration Device of the Fifth Exemplary Embodiment of the Technology of the Present Disclosure

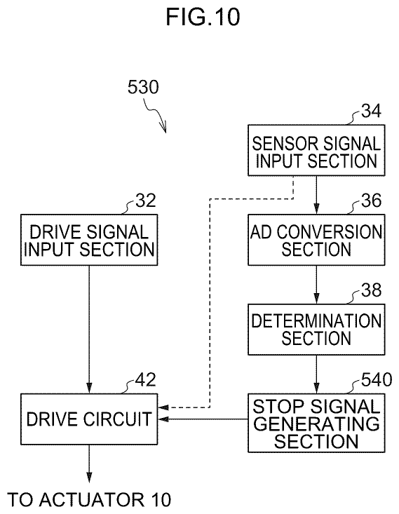

As illustrated in FIG. 10, a controller 530 includes the drive signal input section 32, the sensor signal input section 34, the AD conversion section 36, the determination section 38, a stop signal generating section 540, and the drive circuit 42.

In a case in which it is determined that the magnetic force detected by the magnetic detection sensor 20 is greater than or equal to a threshold value, the stop signal generating section 540 outputs a stop signal for stopping output of the control signal to the actuator 10.

Specifically, the stop signal generating section 540 outputs a stop signal for stopping the output of the drive circuit 42 in order to stop the vibration of the vibrator 12.

The drive circuit 42 causes the vibrator 12 to vibrate in accordance with the drive signal. When this occurs, the drive circuit 42 stops the output of the control signal to the actuator 10 when a stop signal has been input.

### Operation of the Vibration Device of the Fifth Exemplary Embodiment of the Technology of the Present Disclosure

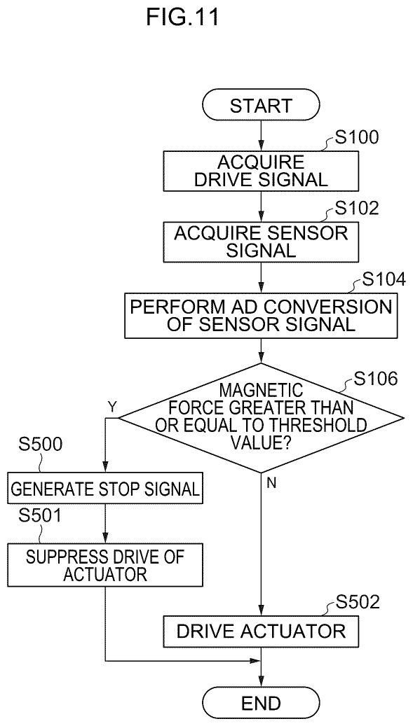

The controller 30 receives input of a drive signal from the outside. Further, the controller 30 receives input of a sensor signal from the magnetic detection sensor 20. When this occurs, the controller 30 repeatedly executes a vibration control processing routine illustrated in FIG. 11.

At step S100, the drive signal input section 32 acquires the input drive signal.

At step S102, the sensor signal input section 34 acquires the input sensor signal.

At step S104, the AD conversion section 36 performs AD conversion of the sensor signal received by the sensor signal input section 34, and outputs a digital signal.

At step S106, the determination section 38 determines whether or not the magnetic force detected by the magnetic detection sensor 20 is greater than or equal to a threshold value, based on the output of the AD conversion section 36. In a case in which the magnetic force detected by the magnetic detection sensor 20 is less than the threshold value, the processing transitions to step S502 without generating a stop signal. On the other hand, in a case in which the magnetic force detected by the magnetic detection sensor 20 is greater than or equal to the threshold value, the processing transitions to step S500.

At step S500, the stop signal generating section 540 outputs a stop signal for stopping the output of the drive circuit 42.

At step S502, the drive circuit 42 causes the vibrator 12 to vibrate in accordance with the drive signal acquired at above-described step S100. At this time, when the stop signal output at above-described step S500 is input, the drive circuit 42 stops output of the control signal to the actuator 10.

As explained above, in the vibration device according to the fifth exemplary embodiment, magnetic force according to displacement of the vibrator is detected by the magnetic detection sensor, a stop signal is generated according to the magnetic force by the controller, and the vibrator of the actuator is caused to vibrate based on the drive signal and the stop signal. This enables the vibrator to be suppressed from contacting the housing.

### Sixth Exemplary Embodiment

Next, explanation follows regarding a vibration device according to a sixth exemplary embodiment. Portions having the same configuration as those in the first exemplary embodiment are appended with the same reference numerals, and explanation thereof is omitted.

The sixth exemplary embodiment is different from the first exemplary embodiment in that the drive circuit performs feedback control using the sensor signal as a feedback signal.

### Configuration of the Vibration Device of the Sixth Exemplary Embodiment of the Technology of the Present Disclosure

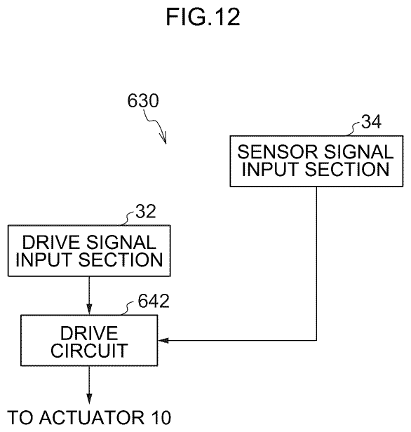

As illustrated in FIG. 12, a controller 630 of the vibration device 100 according to the sixth exemplary embodiment includes the drive signal input section 32, the sensor signal input section 34, and a drive circuit 642.

The sensor signal of the magnetic detection sensor 20 is returned to the drive circuit 642 as a feedback signal. The drive circuit 642 controls vibration of the vibrator 12 in accordance with the magnetic force detected by the magnetic detection sensor 20, by comparing with the input drive signal and outputting, to the actuator 10, a control signal corresponding to the difference

### Operation of the Vibration Device of the Sixth Exemplary Embodiment of the Technology of the Present Disclosure

The controller 630 receives input of a drive signal from the outside. Further, the controller 630 receives input of a sensor signal from the magnetic detection sensor 20.

The drive signal input section 32 acquires the input drive signal. The sensor signal input section 34 acquires the input sensor signal. The drive circuit 642 then outputs a control signal to the actuator 10 in accordance with a difference between the acquired drive signal and the acquired sensor signal, and drives the actuator 10.

As explained above, in the vibration device according to the sixth exemplary embodiment, the magnetic detection sensor detects magnetic force according to displacement of the vibrator, outputs a sensor signal, and the controller causes the vibrator of the actuator to vibrate using the sensor signal as a feedback signal. This enables the vibrator to be suppressed from contacting the housing.

The configuration of control is simple, and conventional feedback circuits can be applied. Further, complex control programs and algorithms are not necessary. Furthermore, since a sensor signal from the magnetic detection sensor is directly applied to the drive circuit, delay becomes minimal, enabling rapid control.

Note that the feedback control explained in the above-described sixth exemplary embodiment may be applied to each of the above-described first exemplary embodiment to fifth exemplary embodiment. Specifically, as illustrated in above-described FIG. 2, FIG. 8, and FIG. 10, a sensor signal is output from the sensor signal input section 34, to the drive circuit 42, as a feedback signal. The drive circuit 42 outputs a control signal to the actuator 10 in accordance with a difference between the acquired drive signal and the acquired sensor signal, and drives the actuator 10.

### Seventh Exemplary Embodiment

Next, explanation follows regarding a vibration device according to a seventh exemplary embodiment. Portions having the same configuration as those in the first exemplary embodiment are appended with the same reference numerals, and explanation thereof is omitted.

The seventh exemplary embodiment is different from the first exemplary embodiment in that the output of the drive circuit is stopped at a timing at which a sensor signal is acquired from the magnetic detection sensor.

### Configuration of the Vibration Device of the Seventh Exemplary Embodiment of the Technology of the Present Disclosure

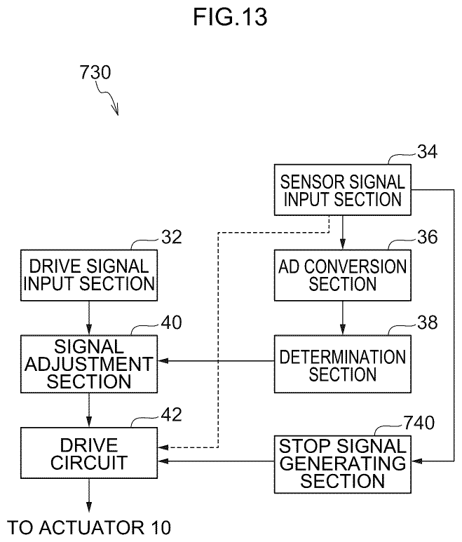

As illustrated in FIG. 13, a controller 730 of the vibration device 100 according to the seventh exemplary embodiment includes the drive signal input section 32, the sensor signal input section 34, the AD conversion section 36, the determination section 38, the signal adjustment section 40, the drive circuit 42, and a stop signal generating section 740.

The stop signal generating section 740 outputs a stop signal that stops the output of the drive circuit 42 at a timing at which the sensor signal input section 34 acquires a sensor signal from the magnetic detection sensor 20.

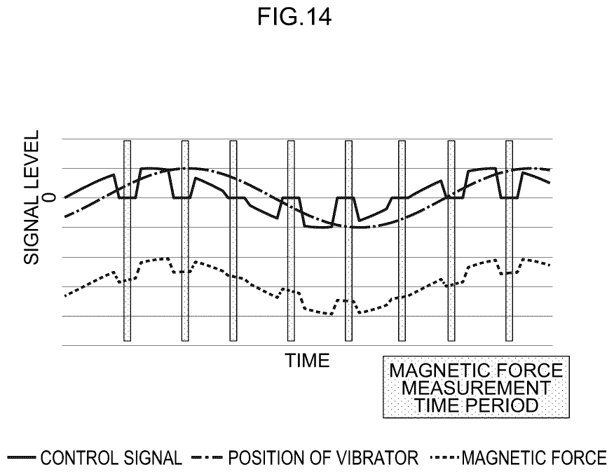

Therefore, as illustrated in FIG. 14, the output of the control signal is stopped for a short period of time in which magnetic force is measured (a period of time in which movement of the vibrator is not inhibited), and more accurate magnetic force is measured and the position of the vibrator 12 is specified.

Note that the other configurations and operations of the vibration device 100 according to the seventh exemplary embodiment are the same as those in the first exemplary embodiment, and explanation thereof is omitted.

The magnetic force measured by the magnetic detection sensor is considered to be a value obtained by adding the magnetic force of the vibrator, which includes the permanent magnet, and the magnetic force generated by the coil in the actuator. In order to detect an accurate position of the vibrator, it is desirable that only the magnetic force of the vibrator be detected. Therefore, in the present exemplary embodiment, by stopping the output of the control signal during magnetic force measurement, the influence of the magnetic force generated by the coil can be suppressed.

### Eighth Exemplary Embodiment

Next, explanation follows regarding a vibration device according to an eighth exemplary embodiment. Portions having the same configuration as those in the first exemplary embodiment are appended with the same reference numerals, and explanation thereof is omitted.

The eighth exemplary embodiment is different from the first exemplary embodiment in that the magnetic detection sensor 20 is provided at a central portion of a side face of the housing 10A, and that a control signal to the actuator is generated so as to apply a traction force, using a voice coil type actuator including a pair of coils.

### Configuration of the Vibration Device of the Eighth Exemplary Embodiment of the Technology of the Present Disclosure

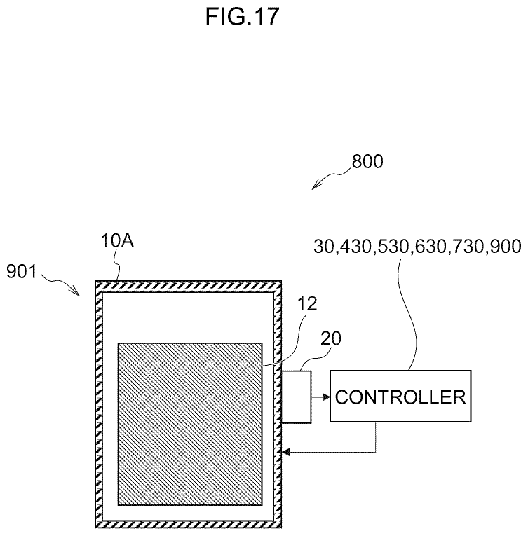

As illustrated in FIG. 17, a vibration device 800 includes an actuator 901, the magnetic detection sensor 20 provided at a surface of the housing 10A, and a controller 900. In the present exemplary embodiment, the magnetic detection sensor 20 is provided at a side face of the housing 10A. FIG. 17 illustrates an example in which the magnetic detection sensor 20 is provided at a central portion of a side face of the housing 10A.

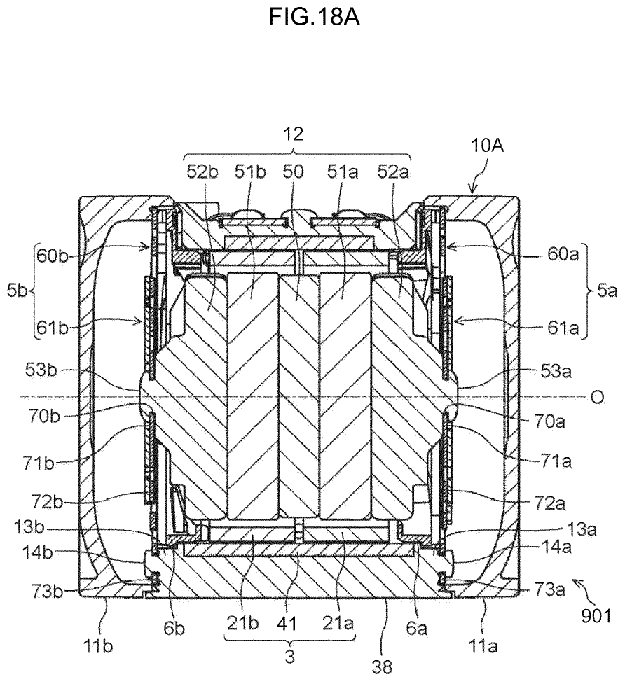

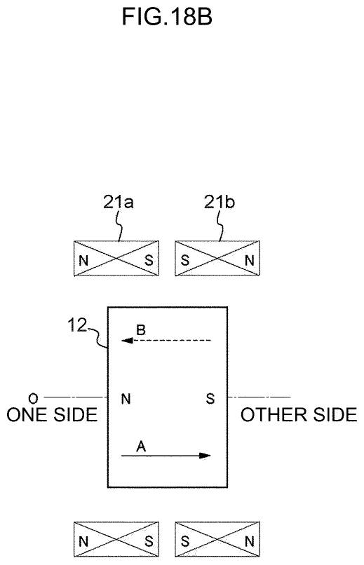

As illustrated in FIG. 18A, the actuator 901 is mainly configured from the housing 10A that configures an outer shell, an electromagnetic drive portion 3 that is provided inside the housing 10A, the vibrator 12 that is capable of vibrating by the electromagnetic drive portion 3, a first support unit 5a and a second support unit 5b which respectively elastically support both ends of the vibrator 12, and a first inner guide 6a and a second inner guide 6b which regulate movement of the first support unit 5a and the second support unit 5b.

Both opening ends of a cylindrical housing main body of the housing 10A are closed by a first cover case 11a and a second cover case 11b.

The electromagnetic drive portion 3 includes a yoke 41 that is made of a cylindrical soft magnetic material and that is disposed at an interior of the housing 10A, and a first coil 21a and a second coil 21b which are attached to an inner face of the yoke 41 in a state of being electrically insulated from the yoke 41.

The first coil 21a and the second coil 21b are wound along the inner face of the yoke 41. The first coil 21a and the second coil 21b can each generate a magnetic field by energization from a terminal.

The vibrator 12 is surrounded by the first coil 21a and the second coil 21b, and is disposed so as to vibrate along a vibration axis O. The vibrator 12 is configured from a disk-shaped magnet 50, a disk-shaped first pole piece 51a and a disk-shaped second pole piece 51b which are disposed so as to sandwich the magnet 50, and a first mass (weight) 52a and a second mass (weight) 52b which are disposed so as to sandwich the magnet 50, the first pole piece 51a, and the second pole piece 51b.

A magnetization direction of the magnet 50 is the vibration axis O direction. The first pole piece 51a and the second pole piece 51b are made of a soft magnetic material, and are attached to the magnet 50 by the magnetic attraction force of the magnet 50, an adhesive, or the like. The first mass 52a and the second mass 52b are made of a non-magnetic material, and are respectively attached to the first pole piece 51a and the second pole piece 51b by an adhesive or the like. Therefore, the magnet 50, the first pole piece 51a, the second pole piece 51b, the first mass 52a, and the second mass 52b which configure the vibrator 12 are integral with each other. The first mass 52a and the second mass 52b are formed with flat contact surfaces with the first pole piece 51a and the second pole piece 51b. Faces on the other side of the contact faces are formed in a spiral shape with the vibration axis O as a center axis, and distal end portions 53a and 53b on the center axis thereof projecting out furthest toward the outside.

In the vibrator 12 configured in this manner, both end portions in the vibration axis O direction, namely, the distal end portions 53a and 53b of the first mass 52a and the second mass 52b, respectively, are supported by the first support unit 5a and the second support unit 5b.

The first support unit 5a is configured from a first damper 60a (a first plate spring), and a first elastic member 61a provided at one face of the first damper 60a.

A support portion 71a, which includes a hole 70a, is formed at a central portion of the first damper 60a. The first damper 60a is coupled to the vibrator 12 via the hole 70a. More specifically, the distal end portion 53a of the first mass 52a is inserted through the hole 70a, and the distal end portion 53a is crimped by being crushed.

Further, the first damper 60a includes three arm portions 72a extending spirally toward the outer circumference from the support portion 71a. The respective arm portions 72a are formed at regular intervals at 120° pitches about the vibration axis O. An outer peripheral end of each arm portion 72a is coupled to an annular frame portion 73a along an inner face of the housing main body. The frame portions 73a are coupled to each other by flange portions 13a projecting radially inward at three positions at the inner face of the housing main body at 120° pitch positions about the vibration axis O.

The first damper 60a is configured by a single metal plate spring or plural metal plate springs, and in the present exemplary embodiment, for example, a thin plate of stainless steel (a spring material) is used. The material of the first damper 60a is not limited to metal, and may be a composite material including resin or fibers. Materials that are resistant to fatigue and that are excellent in flexibility are desirable.

The first damper 60a configured in this manner is elastically deformable within a predetermined range in the vibration axis O direction and an intersecting direction including a radial direction that is perpendicular to the vibration axis O. Note that this predetermined range corresponds to an amplitude range of the vibrator 12 in a case in which the vibrator 12 is normally used as the actuator 901. Therefore, the predetermined range is a range in which at least the first damper 60a does not contact the housing 10A, and is a range in which the limit of the elastic deformation of the first damper 60a is not exceeded.

The first elastic member 61a is in the shape of a plate that follows a shape from the support portion 71a of the first damper 60a to a certain range of each arm portion 72a, and is fixed to one face of the first damper 60a. Vibration of the first damper 60a is damped by elastic deformation of the first elastic member 61a.

The second support unit 5b has the same configuration as the first support unit 5a, and includes a second damper 60b (a second plate spring) and a second elastic member 61b. Note that in the present exemplary embodiment, the second damper 60b and the first damper 60a each have the same shape and are formed from the same material, and the second elastic member 61b and the first elastic member 61a each have the same shape and are formed from the same material. Three arm portions 72b of the second damper 60b extend from a support portion 71b formed with the hole 70b to an annular frame portion 73b. The second damper 60b is coupled to the vibrator 12 by inserting the distal end portion 53b of the second mass 52b into the hole 70b and crushing and crimping. Further, the second damper 60b is coupled to three flange portions 13b, in which the annular frame portion 73b projects out from the inner face of the housing main body, by a boss portion 14b of the flange portions 13b being inserted and crushed and crimped through the through hole formed in the frame portion 73b. Note that a spiraling direction of each arm 72b of the second damper 60b is opposite to a spiraling direction of each arm 72a of the first damper 60a. As a result, during vibration, the vibrator 12 receives torque in opposite directions from the first damper 60a and the second damper 60b, respectively, and therefore, the vibrator 12 does not rotate about the vibration axis O even if the vibrator 12 is displaced in the vibration axis O direction.

The first inner guide 6a is at one side in the vibration axis O direction of the actuator 901, and is provided further toward another side (a central portion of the housing 10A) in the vibration axis O direction than the first support unit 5a. The second inner guide 6b is at the other side in the vibration axis O direction of the actuator 901, and is provided further toward the one side (a central portion of the housing 10A) in the vibration axis O direction than the second support unit 5b. Namely, the first inner guide 6a and the second inner guide 6b are provided further toward the center in the vibration axis O direction than the first support unit 5a and the second support unit 5b inside the housing 10A.

As illustrated in FIG. 18B, in a state in which the actuator 901 is not supplying electrical current to the first coil 21a or the second coil 21b, the vibrator 12 supported by the first damper 60a and the second damper 60b is positioned at the center of the first coil 21a and the second coil 21b.

When the vibrator 12 is vibrated, alternating current is supplied to the first coil 21a and the second coil 21b in directions in which magnetic fields of opposite polarities are alternately generated. Namely, the same polarity is generated at adjacent portions of the first coil 21a and the second coil 21b.

In the case of the polarity illustrated in FIG. 18B, for example, thrust toward the other side in the vibration axis O direction (the right side in FIG. 18B), indicated by the solid arrow A, is generated at the vibrator 12, and when current flowing to the first coil 21a and the second coil 21b is inverted, thrust toward the one side in the vibration axis O direction (the left side in FIG. 18B), indicated by the dotted arrow B, is generated at the vibrator 12.

When alternating current is supplied to the first coil 21a and the second coil 21b in this manner, the vibrator 12 vibrates along the vibration axis O while receiving biasing force by the first damper 60a and the second damper 60b from both sides.

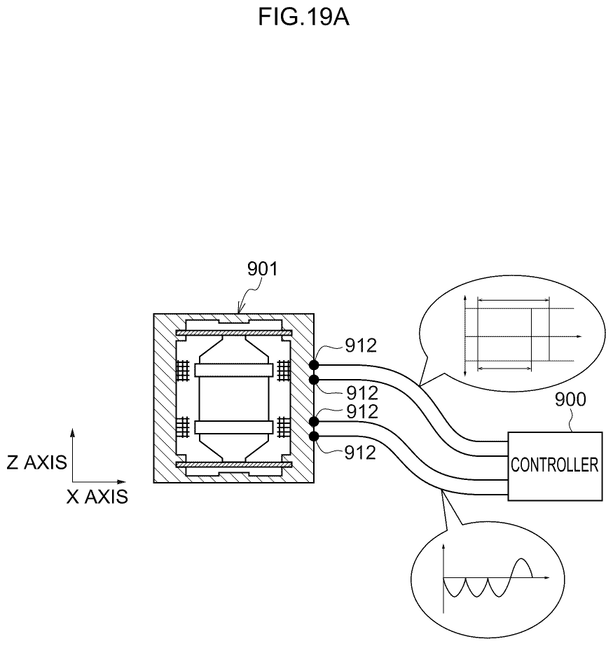

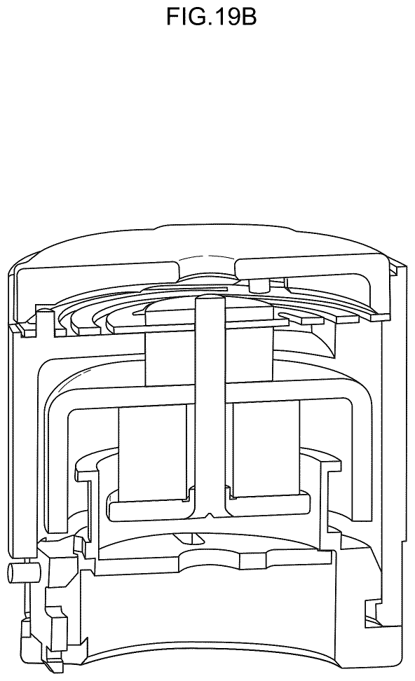

As illustrated in FIG. 19A, the first coil 21a and the second coil 21b are each connected to respective independent external connection portions 912, and the controller 900 controls the respective levels of drive signals output to each independent external connection portion 912 based on detection information of the magnetic detection sensor 20.

For example, the controller 900 detects the amplitude of the vibrator 12 based on the detection information of the magnetic detection sensor 20, and controls the respective levels of the drive signals output to each independent external connection portion 912 so as to control the deviation of the amplitude in the positive and negative directions. Therefore, independent signal control of the first coil 21a and the second coil 21b enables highly accurate and more complex vibration control (such as traction force presentation). This enables vibration expression such as a traction force, a resistance feeling of the object surface, and a fine unevenness feeling of the object surface to be realized.

Here, the traction force illusion refers to indistinctly perceiving acceleration that changes slowly according to nonlinearity of perception. As an illusion generation condition for stimulus design, for example, vibration is applied in a waveform that is asymmetric in the time direction (a shape close to a sawtooth wave).

Further, vibration frequencies that are effective for the human body, such as traction force illusion or vibration detection by a bio-tactile sensor (receptor), are said to be in a low band (less than or equal to 100 Hz).

If the resonance frequency of the actuator 901 is lowered while maintaining a high acceleration, the amplitude amount of the vibrator tends to be increased, and the amplitude limit is easily exceeded.

Further, in a case in which an additional mass due to gripping or the like fluctuates significantly, the amplitude amount is further increased, such that amplitude control becomes more important.

Therefore, in the present exemplary embodiment, the amplitude amount is monitored by the magnetic detection sensor 20 and vibration control is performed, thereby enabling driving at a low frequency while avoiding contact with the housing 10A.

Further, amplitude control can be performed from detection of the displacement amount, and therefore, a configuration that requires mechanical amplitude limitation of the actuator is not necessary. For example, vibration control is possible, even in a case in which there is no cover case in the vibration direction.

Note that the other configurations of the vibration device 800 are the same as those in the first exemplary embodiment, and explanation thereof is omitted.

Further, vibration control may be performed similarly to the controller 30 explained in the first exemplary embodiment. In such a case, the determination section 38 of the controller 30 determines whether or not a distance between the housing 10A and a position of the vibrator 12 detected by the magnetic detection sensor 20 is less than a threshold value based on the output of the AD conversion section 36. In a case in which it is determined that the distance between the housing 10A and the position of the vibrator 12 detected by the magnetic detection sensor 20 is less than the threshold value, the signal adjustment section 40 performs the following processing. Namely, the signal adjustment section 40 adjusts the level of the drive signal, based on the distance between the housing 10A and the position of the vibrator 12 detected by the magnetic detection sensor 20, so as to be suppressed.

Further, vibration control may be performed similarly to the controller 30 explained in the second exemplary embodiment. In such a case, the determination section 38 of the controller 30 determines whether or not a distance between the housing 10A and a position of the vibrator 12 detected by the magnetic detection sensor 20 is less than a threshold value based on the output of the AD conversion section 36. In a case in which it is determined that the distance between the housing 10A and the position of the vibrator 12 detected by the magnetic detection sensor 20 is less than the threshold value, the signal adjustment section 40 performs the following processing. Namely, the signal adjustment section 40 adjusts the level of the drive signal in accordance with a combination of the distance between the housing 10A and the position of the vibrator 12 detected by the magnetic detection sensor 20, and the level of the drive signal.

Further, vibration control may be performed similarly to the controller 30 explained in the third exemplary embodiment. In such a case, the determination section 38 of the controller 30 determines whether or not a distance between the housing 10A and a position of the vibrator 12 detected by the magnetic detection sensor 20 is less than a threshold value based on the output of the AD conversion section 36. The signal adjustment section 40 specifies the direction of movement and the acceleration of the vibrator 12 based on a change in the position of the vibrator 12 detected by the magnetic detection sensor 20, and adjusts the level of the drive signal, based on the direction of movement and the acceleration of the vibrator 12, so as to be suppressed.

Further, vibration control may be performed similarly to the controller 430 explained in the fourth exemplary embodiment. In such cases, in a case in which the distance between the housing 10A and the position of the vibrator 12 detected by the magnetic detection sensor 20 is less than a threshold value, the brake signal generating section 440 of the controller 430 outputs a brake signal for stopping the driving of the vibrator 12.

Further, vibration control may be performed similarly to the controller 530 explained in the fifth exemplary embodiment. In such cases, in a case in which the distance between the housing 10A and the position of the vibrator 12 detected by the magnetic detection sensor 20 is less than a threshold value, the stop signal generating section 540 of the control portion 530 outputs a stop signal for stopping the output of the control signal to the actuator 10.

Further, vibration control may be performed similarly to the controller 630 explained in the sixth exemplary embodiment. In such a case, the sensor signal of the magnetic detection sensor 20 is returned as a feedback signal to the drive circuit 642 of the controller 630. The drive circuit 642 controls vibration of the vibrator 12 in accordance with the magnetic force detected by the magnetic detection sensor 20, by comparing with the input drive signal and outputting a control signal corresponding to the difference to the actuator 10.

Further, vibration control may be performed similarly to the controller 730 explained in the seventh exemplary embodiment. In such a case, the stop signal generating section 740 of the control portion 730 outputs a stop signal for stopping the output of the driving circuit 42 at a timing at which the sensor signal input section 34 acquires a sensor signal from the magnetic detection sensor 20.

### EXPERIMENTAL EXAMPLES

As an experimental example for examining the mounting position of a magnetic sensor for detecting the position of a vibrator by picking up a change in magnetic flux leakage with a magnetic sensor, magnetic field analysis was performed using FEMTET (registered trademark) to confirm the distribution of magnetic flux leakage.

Since a magnetic sensor picks up only a uniaxial direction value of the magnetic flux density, the magnetic flux density was evaluated not in magnitude, but in terms of an x component (radial direction) and a z component (axial direction) (see FIG. 19A).

In a magnetic circuit including a pair of coils, a magnetic circuit of a magnet sandwiched between pole pieces with respect to a cylindrical yoke was used, and a neodymium magnet was used as a magnet configuring the vibrator 12, and the configuration was symmetrical in the z-axis direction (the axial direction).

As illustrated in FIG. 19B, in a magnetic circuit including a single coil, a magnetic circuit including a permanent magnet inserted to an interior of a pot-shaped yoke was used, and a ferrite magnet was used as a magnet configuring the vibrator 12, and the configuration was asymmetric in the z-axis direction (up and down). The yoke position in the axial direction is not limited to the housing center, but is arbitrary, and is determined based on positional relationships with the coil and the suspension. There are a housing top face and a housing bottom face in the axial direction of the pot-shaped yoke, and a coil is disposed at an inner side of the pot-shaped yoke. Further, the pot-shaped yoke is open at the bottom face side.

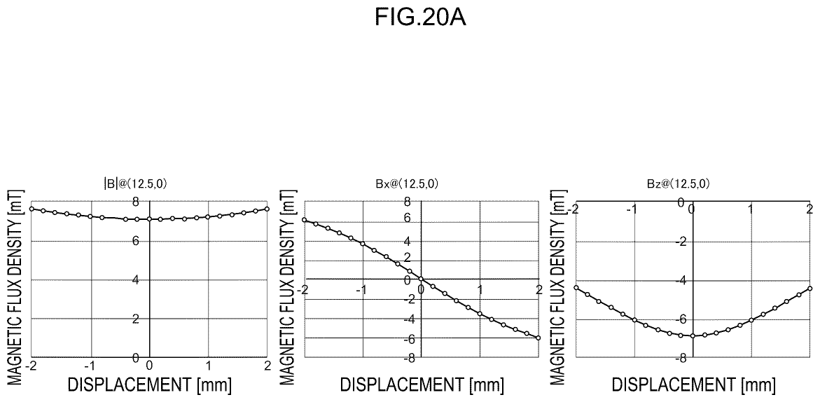

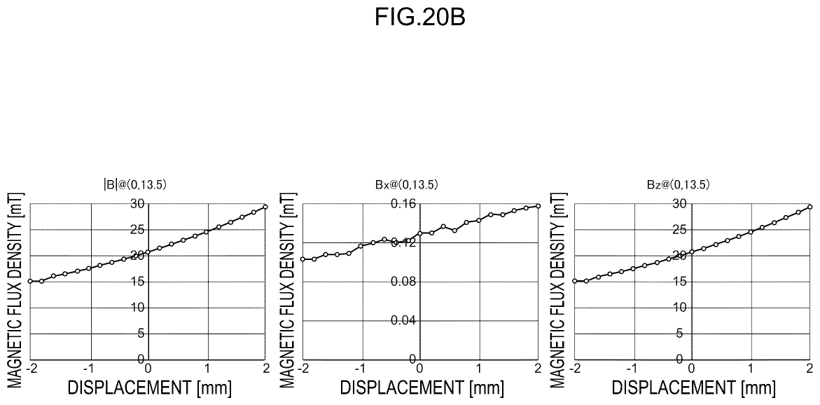

FIG. 20A illustrates, in order from the left, the magnitude, the x component, and the z component of magnetic flux with respect to displacement at the center of a side face of a housing of a magnetic circuit including a pair of coils.

FIG. 20B illustrates, in order from the left, the magnitude, the x component, and the z component of magnetic flux with respect to displacement at the center of the top face of the housing of a magnetic circuit including a pair of coils.

The x component of the magnetic flux with respect to displacement at the center of a side face of the housing changed linearly, and there was no offset. Further, the z component of the magnetic flux with respect to displacement at the center of a side face of the housing changed quadratically, and became a minimum at displacement 0.

The x component of the magnetic flux with respect to displacement at the center of the top face of the housing changed linearly, with an offset, and the offset amount was greater than the change amount. Further, the z component of the magnetic flux with respect to displacement at the center of the top face of the housing changed linearly, with an offset, and the offset amount was greater than the change amount.

Therefore, it was found that in a magnetic circuit including a pair of coils, it is effective to detect a change in the x component of magnetic flux density at the center of a side face of the housing.

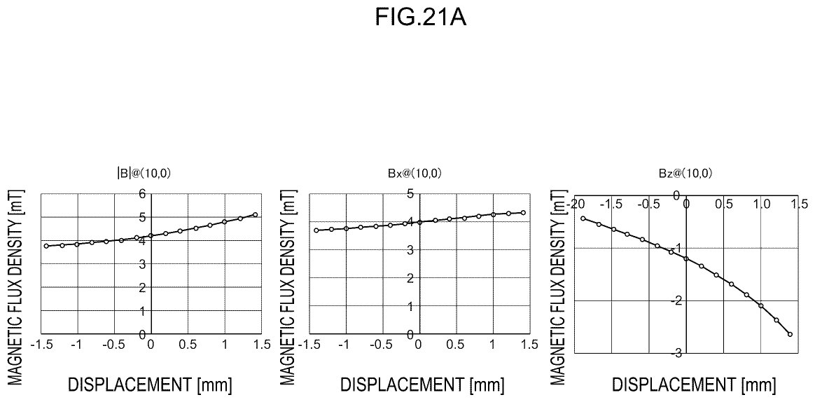

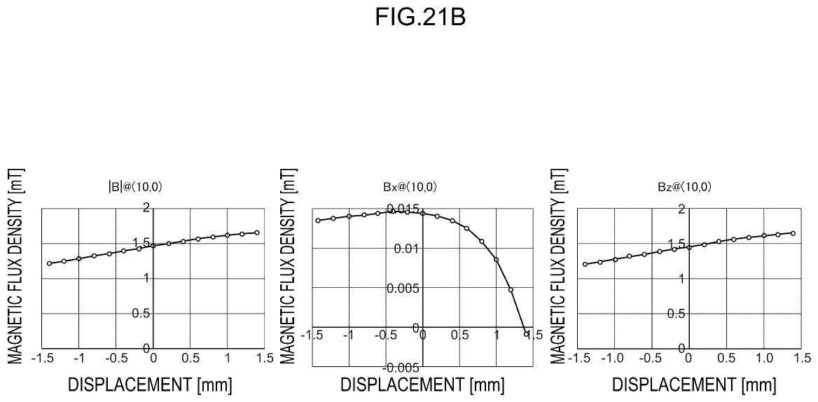

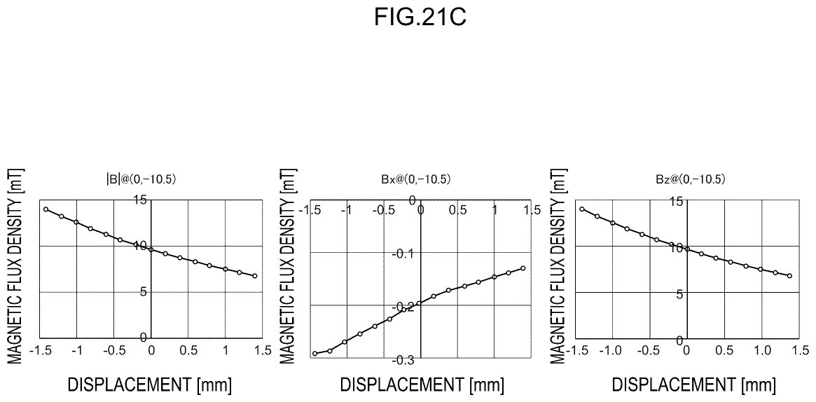

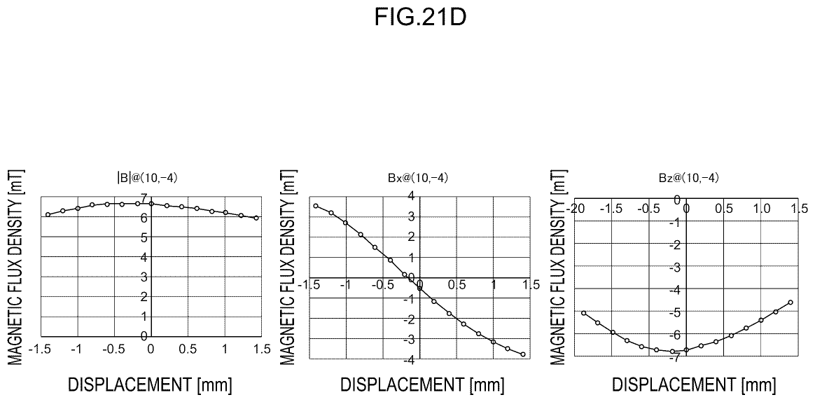

FIG. 21A illustrates, in order from the left, the magnitude, the x component, and the z component of magnetic flux with respect to displacement at the center of a side face of a housing of a magnetic circuit including a single coil.

FIG. 21B illustrates, in order from the left, the magnitude, the x component, and the z component of magnetic flux with respect to displacement at the center of a top face of a housing of a magnetic circuit including a single coil.

FIG. 21C illustrates, in order from the left, the magnitude, the x component, the z component, and the angle of magnetic flux with respect to displacement at the center of a bottom face of a housing of a magnetic circuit including a single coil.

The x component of the magnetic flux with respect to displacement at the center of a side face of the housing changed linearly, with an offset, and the offset amount was greater than the change amount. Further, the z component of the magnetic flux with respect to displacement at the center of a side face of the housing changed linearly, with an offset, and the offset amount was greater than the change amount.

The x component of the magnetic flux with respect to displacement at the center of the top face of the housing changed quadratically in a distorted manner, with a maximum near displacement 0. Further, the z component of the magnetic flux with respect to displacement at the center of the top face of the housing changed linearly, with an offset, and the offset amount was greater than the change amount.

The x component of the magnetic flux with respect to displacement at the center of the bottom face of the housing changed linearly, with an offset, and the offset amount was greater than the change amount. Further, the z component of the magnetic flux with respect to displacement at the center of the bottom face of the housing changed linearly, with an offset, and the offset amount was greater than the change amount.

Therefore, there were no positions or components at the center of the side face, the center of the top face, and the center of the bottom face at which it was easy to detect changes in magnetic flux density.

FIG. 21D illustrates, in order from the left, the magnitude, the x component, and the z component of magnetic flux with respect to displacement at positions that are separated by a predetermined distance from the center of the side face of the housing of a magnetic circuit including a single coil (at positions at which magnetic flux lines are parallel to the z direction (axial direction) at the side face of the housing).

The x component of the magnetic flux with respect to displacement 4 mm below the center of the side face of the housing changed linearly, and there was no offset. Further, the z component of the magnetic flux with respect to displacement 4 mm below the center of the side face of the housing changed quadratically, with a minimum at displacement 0.

Therefore, it was found that in a magnetic circuit including a single coil, it is effective to detect a change in the x component of magnetic flux density 4 mm below the center of the side face of the housing.

In this manner, it was found that providing the magnetic sensor at the side face of the housing, rather than being provided at the top face of the housing, is effective in detecting a change in the x component of magnetic flux density. Namely, by providing the magnetic sensor at the side face of the housing, the magnetic sensor can accurately detect the displacement amount of the vibrator. Most preferably, the magnetic sensor is provided at a position at which the magnetic poles are inverted; however, the magnetic sensor may be provided other than at a central portion as long as the magnetic sensor is provided at a side face of the housing.

In the technology of the present disclosure, displacement of the vibrator or the housing is detected by a displacement detection section. Further, the controller causes the vibrator to vibrate based on the input drive signal and detection information of the displacement detection section.

In this manner, detecting displacement of the vibrator or the housing, and causing the vibrator to vibrate based on the detection information and the drive signal enables the vibrator to be suppressed from contacting the housing.

The displacement detection section according to the technology of the present disclosure is a magnetic detection sensor that detects a magnetic force in accordance with a position of the vibrator, which changes on input of the drive signal, and the controller can control a level of a control signal for causing the vibrator to vibrate in accordance with the drive signal based on the detection information of the displacement detection section.

The controller according to the technology of the present disclosure can control a level of the control signal based on the detection information of the displacement detection section and a level of the drive signal.

The controller according to the technology of the present disclosure can specify the direction of movement and the acceleration of the vibrator based on a change in the detection information of the displacement detection section, and can control the level of the control signal based on the direction of movement and the acceleration.

The controller according to the technology of the present disclosure can stop output of the control signal in accordance with a detection timing by the displacement detection section.

The controller according to the technology of the present disclosure can control the level of the control signal by adjusting the level of the drive signal based on the detection information of the displacement detection section.

The controller according to the technology of the present disclosure can adjust the level of the drive signal, at a set compression ratio, in a case in which the detected magnetic force exceeds a threshold value.

The controller according to the technology of the present disclosure can adjust the level of the drive signal by replacing the drive signal with a brake signal in a case in which the detected magnetic force exceeds a threshold value.

The controller according to the technology of the present disclosure can stop output of the control signal in a case in which the detected magnetic force exceeds a threshold value.

The controller according to the technology of the present disclosure can control the level of the control signal using the detected magnetic force as a feedback signal.

The magnetic detection sensor according to the technology of the present disclosure can be provided at a side face of the housing.

The vibration device according to the technology of the present disclosure further includes: a cylindrical electromagnetic drive portion that is provided at an interior of the housing; and a pair of plate springs that respectively support one end portion and another end portion, in a vibration axis direction of the vibrator, of the vibrator, wherein: the vibrator is provided at a radial direction inner side of the electromagnetic drive portion and is supported so as to be capable of vibrating along a vibration axis; the vibrator includes a magnet having a magnetization direction in the vibration axis direction, a pair of pole pieces that are made of a soft magnetic material and that sandwich the magnet from both sides along the vibration axis, and a pair of weights that are made of a non-magnetic material and that sandwich the pair of pole pieces from both sides along the vibration axis; the electromagnetic drive portion includes a pair of coils that are provided along the vibration axis with an interval and that are respectively formed in a cylindrical shape, and a cylindrical yolk that is made of a soft metallic material, that is provided at a radial direction outer side of the pair of coils, and that is formed so as to project out further to a vibration axis direction outer side than the pair of coils; and the pair of coils can be connected to respective independent external connection portions.

The controller according to the technology of the present disclosure can control the respective levels of the drive signals output to each independent external connection portion based on the detection information of the displacement detection section.

Note that the technology of the present disclosure is not limited to the above-described exemplary embodiments, and various modifications and applications are possible within a range that does not depart from the gist of the technology of the present disclosure.

Since a magnetic detection sensor detects a combined magnetic flux of a magnetic flux leaking from a drive coil and a magnetic flux of the vibrator, it is difficult to detect displacement of the vibrator with high accuracy. Therefore, in the controller according to the present exemplary embodiment, the magnetic flux of the vibrator may be more accurately calculated by predicting the magnetic force from the drive coil of the actuator based on the drive signal, and subtracting the predicted magnetic force from the detection data of the magnetic detection sensor. Calculating the magnetic flux of the vibrator more accurately enables displacement detection of the vibrator with higher accuracy.

The technology of the present disclosure may be applied to products (for example, a chair, a bed, a floor, or the like) that use plural actuators. In such a case, it is not necessary to provide the displacement detection section to all of the actuators, and it is sufficient to provide the displacement detection section to at least one of the actuators.

In the above-described exemplary embodiments, an example in which a voice coil type actuator is used as an actuator has been described; however, the present disclosure is not limited thereto, and actuators other than a voice coil type actuator may be used.

Further, although explanation has been made taking as an example a case in which a magnetic detection sensor is used as a displacement detection section that detects displacement of the vibrator, the present disclosure is not limited thereto. A displacement detection section that detects displacement of the housing may be used. For example, an electrostatic film type sensor may be used to detect deformation of the housing, the magnitude of vibration, compression on equipment, or the like of a voice coil type actuator, and driving of the actuator may be controlled based on the detection result and a drive signal.

Further, although explanation has been made taking as an example a case in which a magnetic detection sensor is provided at an outer side of a housing of an actuator, the present disclosure is not limited thereto. For example, a magnetic detection sensor may be provided at an inner side of the housing of the actuator. In such a case, incorporation of the magnetic detection sensor itself at the interior of the actuator enables miniaturization and uniformity of positional relationships with the vibrator.

Further, the controller may control residual vibration of the vibrator after the operation of causing the vibrator to vibrate based on the drive signal.

The disclosure of Japanese Patent Application No. 2022-202447 is hereby incorporated by reference in its entirety.

All documents, patent applications, and technical standards described herein are hereby incorporated by reference to the same extent as if each document, patent application, and technical standard were specifically and individually described as being incorporated by reference.

1-13. (canceled)

14. A vibration device, comprising:
a vibrator that imparts vibration;
a displacement detection section that detects displacement of the vibrator; and
a controller that causes the vibrator to vibrate based on an input drive signal and detection information of the displacement detection section,
wherein:
the vibrator generates magnetic flux;
the displacement detection section is a magnetic detection sensor that detects the magnetic flux; and
the magnetic detection sensor is provided at a side face of a housing.

15. The vibration device according to claim 14, wherein the controller specifies a position of the vibrator based on the magnetic flux detected by the displacement detection section; and
the controller controls a level of a control signal for causing the vibrator to vibrate, in accordance with the drive signal, based on a distance between the specified position of the vibrator and the housing.

16. The vibration device according to claim 14, wherein:
the magnetic detection sensor is provided at the side face, which is a side face in a radial direction that intersects with an axial direction in which the vibrator vibrates.

17. The vibration device according to claim 16, wherein the magnetic detection sensor detects a change in magnetic flux in the radial direction.

18. The vibration device according to claim 16, wherein the magnetic detection sensor is provided at a position at which magnetic poles of a component of the magnetic flux in the radial direction are inverted.

19. The vibration device according to claim 15, wherein the controller controls a level of a control signal for causing the vibrator to vibrate in accordance with the drive signal by adjusting a level of the drive signal, based on a distance between the housing and a specified position of the vibrator.

20. The vibration device according to claim 19, wherein, in a case in which the distance between the housing and the specified position of the vibrator is less than a threshold value, the controller adjusts the level of the drive signal by a set compression ratio.

21. The vibration device according to claim 19, wherein, in a case in which the distance between the housing and the specified position of the vibrator is less than a threshold value, the controller replaces the drive signal with a brake signal and adjusts the level of the drive signal until the distance between the housing and the specified position of the vibrator exceeds the threshold value.

22. The vibration device according to claim 15, wherein, in a case in which a distance between the housing and a specified position of the vibrator is less than a threshold value, the controller stops output of a control signal for causing the vibrator to vibrate in accordance with the drive signal until the detected magnetic flux is less than a threshold value.

23. The vibration device according to claim 15, wherein:
a sensor signal is output based on the detected magnetic flux; and
the controller controls a level of a control signal for causing the vibrator to vibrate in accordance with the drive signal, based on a difference between the drive signal and the sensor signal.

24. The vibration device according to claim 15, wherein:
the controller specifies a direction of movement and an acceleration of the vibrator based on a change in a specified position of the vibrator; and
the controller controls a level of a control signal for causing the vibrator to vibrate in accordance with the drive signal, based on the direction of movement and the acceleration.

25. The vibration device according to claim 15, wherein:
the controller stops output of a control signal for causing the vibrator to vibrate in accordance with the drive signal, in response to a detection timing by the displacement detection section; and
the controller specifies a position of the vibrator based on the detected magnetic flux.

26. The vibration device according to claim 15, wherein:
a sensor signal is output based on the detected magnetic flux; and
the controller controls a level of a control signal for causing the vibrator to vibrate in accordance with the drive signal, using the sensor signal as a feedback signal.

27. The vibration device according to claim 14, further comprising:
a cylindrical electromagnetic drive portion that is provided at an interior of the housing; and
a pair of plate springs that respectively support one end portion and another end portion, in a vibration axis direction of the vibrator, of the vibrator,
wherein:
the vibrator is provided at a radial direction inner side of the electromagnetic drive portion and is supported so as to be capable of vibrating along a vibration axis;
the vibrator includes a magnet having a magnetization direction in the vibration axis direction, a pair of pole pieces that are made of a soft magnetic material and that sandwich the magnet from both sides along the vibration axis, and a pair of weights that are made of a non-magnetic material and that sandwich the pair of pole pieces from both sides along the vibration axis;
the electromagnetic drive portion includes a pair of coils that are provided along the vibration axis with an interval and that are respectively formed in a cylindrical shape, and a cylindrical yolk that is made of a soft metallic material, that is provided at a radial direction outer side of the pair of coils, and that is formed so as to project out further to a vibration axis direction outer side than the pair of coils; and
the pair of coils are connected to respective independent external connection portions.

28. The vibration device according to claim 27, wherein the controller controls a level of respective drive signals output to each independent external connection portion, based on the detected information of the displacement detection section.

29. A vibration device, comprising:
a vibrator that imparts vibration;
a displacement detection section that detects displacement of the vibrator; and
a controller that causes the vibrator to vibrate based on an input drive signal and detection information of the displacement detection section,
wherein:
the vibrator generates magnetic flux;
the displacement detection section is a magnetic detection sensor that detects the magnetic flux;
the controller specifies a direction of movement and an acceleration of the vibrator based on a change in the magnetic flux detected by the displacement detection section; and
the controller controls a level of a control signal for causing the vibrator to vibrate, in accordance with the drive signal, based on the direction of movement and the acceleration.

30. A vibration device, comprising:
a vibrator that imparts vibration;
a displacement detection section that detects displacement of the vibrator; and
a controller that causes the vibrator to vibrate based on an input drive signal and detection information of the displacement detection section,
wherein:
the vibrator generates magnetic flux;
the displacement detection section is a magnetic detection sensor that detects the magnetic flux;
the controller controls a level of a control signal for causing the vibrator to vibrate, in accordance with the drive signal, based on the detection information of the displacement detection section;
the controller stops output of the control signal for causing the vibrator to vibrate, in accordance with the drive signal, in response to a detection timing by the displacement detection section;
the controller specifies a position of the vibrator based on the detected magnetic flux; and
the controller controls the level of the control signal based on the position of the vibrator.
